(19) United States
(12) Patent Application Publication
(10) Pub. No.: US 2026/0269165 A1
(43) Pub. Date: Sep. 10, 2026

(54) FIELD EMISSION DEVICE HAVING AUTOMATIC CURRENT LIMITER

(71) Applicant: LG ELECTRONICS INC., Seoul (KR)

(72) Inventors: Hyojin NAM, Seoul (KR); Byungkee LEE, Seoul (KR); Jinah KIM, Seoul (KR); Giwon LEE, Seoul (KR); Youngsik KIM, Seoul (KR); Jeongsoon YIM, Seoul (KR); Eunju HONG, Seoul (KR)

(73) Assignee: LG ELECTRONICS INC., Seoul (KR)

(21) Appl. No.: 19/164,330

(22) PCT Filed: Mar. 17, 2023
(86) PCT No.: PCT/KR2023/003574

§ 371 Date: Sep. 11, 2025

(51) Int. Cl. H01J 1/304; H01J 9/02

(52) U.S. Cl. CPC H01J 1/3042; H01J 9/025; H01J 2201/3195

(57) ABSTRACT

The present invention relates to a field emission device having an automatic current limiter, the field emission device comprising: a silicon substrate; a plurality of probes which are disposed on the silicon substrate; an insulating layer which is disposed between the plurality of probes; a gate electrode which is disposed on the insulating layer and formed to cause the plurality of probes to emit electrons; an anode electrode which is arranged to be spaced apart from the plurality of probes and which the electrons emitted from the plurality of probes reach; and a cathode electrode which is disposed under the silicon substrate, wherein the plurality of probes are formed of a highly resistive layer.

### TECHNICAL FIELD

The present disclosure relates to a field emission device having an automatic current limiter.

### BACKGROUND ART

In a probe-type field emission device, the field emission current density is very sensitive to a shape of a probe (height, probe radius, etc.).

In particular, the probe radius is on the order of several nanometers in size, and a slight difference in the radius causes a rapid increase in current density of a specific probe, which causes the shape of the probe to be dull or causes an electrical short to the gate electrode due to micro arc plasma, causing a serious problem in reliability.

In the case of a molybdenum (Mo) probe-type field emitter using a Spindt process, a structure that limits the current by forming a highly resistive layer under the probe has been proposed, and it has been reported that reliability has been greatly enhanced through this.

However, in the case of a silicon probe using an etching process of a silicon wafer, there is a problem in that it is difficult to form a separate resistive layer under the probe by using the wafer itself, and therefore, there is no report on a current limiting resistive layer.

### DISCLOSURE OF INVENTION

### Technical Problem

An aspect of the present disclosure is to solve the foregoing and other problems, and to provide a field emission device capable of automatically limiting a current using a highly resistive layer.

### Solution to Problem

In order to achieve the foregoing or other objectives, according to one aspect of the present disclosure, a field emission device having an automatic current limiter according to an embodiment of the present disclosure may include a silicon substrate, a plurality of probes disposed on the silicon substrate, an insulating layer disposed between the plurality of probes, a gate electrode disposed on the insulating layer to emit electrons from the plurality of probes, an anode electrode disposed to be spaced apart from the plurality of probes so as to allow electrons emitted from the plurality of probes to reach, and a cathode electrode disposed below the silicon substrate, wherein the plurality of probes are disposed with a highly resistive layer.

In an embodiment, the highly resistive layer may be formed of silicon grown as an epitaxial layer.

In an embodiment, a resistance of the probe due to the highly resistive layer may have a range of 10M to 1G (ohm).

In an embodiment, a feedback resistance may be generated on each of the plurality of probes as the highly resistive layer is deposited.

In an embodiment, a uniformity of a current may increase as a resistance value of the feedback resistor increases.

In an embodiment, tips of the plurality of probes may be doped with phosphorus.

In an embodiment, phosphorus may be implanted when the plurality of probes are silicon disposed with an undoped epitaxial layer.

In an embodiment, a protective layer coating may be disposed on the plurality of probes.

In an embodiment, the feedback resistance of the probe may increase as a height of the plurality of probes increases.

In an embodiment, the plurality of probes may be formed through a dual etch so as to allow the height of the plurality of probes to be above a predetermined height.

### Advantageous Effects of Invention

According to the present disclosure, a highly resistive epitaxial layer deposited on a silicon wafer is disposed with a highly resistive layer, thereby configuring a current limiting structure. Through this, a current uniformity between probes may be greatly enhanced, thereby greatly improving reliability.

### BRIEF DESCRIPTION OF DRAWINGS

FIG. 1 is a conceptual diagram showing a probe-type field emission device integrated with a current limiting resistor.

FIG. 2 is a conceptual diagram showing a conventional silicon probe-type field emission device.

FIG. 3 is a graph showing the I-V characteristics of a probe-type field emission device.

FIG. 4 is a conceptual diagram showing a current limiting structure of a Spindt probe-type field emission device.

FIG. 5 is a conceptual diagram showing the principle of Fowler-Nordheim tunneling.

FIG. 6 is a drawing showing a silicon emitter circuit diagram of the present disclosure.

FIG. 7 is a graph showing a change in tunneling current due to resistance formation.

FIG. 8 is a process diagram for explaining a sequence of manufacturing a field emission device of the present disclosure.

FIG. 9 is a conceptual view for explaining a protective layer coating according to one embodiment of the present disclosure.

FIG. 10 is a conceptual diagram for explaining a probe structure according to various embodiments of the present disclosure.

### MODE FOR THE INVENTION

It should be noted that the technical terms used herein are merely used to describe a specific embodiment, but are not intended to limit the present disclosure. In 1s addition, a singular expression used herein may include a plural expression unless clearly defined otherwise in the context. A suffix “module” or “part” used for elements disclosed in the following description is merely intended for easy description of the specification, and the suffix itself is not intended to have any special meaning or function.

As used herein, terms such as “comprise” or “include” should not be construed to necessarily include all elements or steps described herein, and should be construed not to include some elements or some steps thereof, or should be construed to further include additional elements or steps.

In addition, in describing technologies disclosed herein, when it is determined that a detailed description of known technologies related thereto may unnecessarily obscure the subject matter disclosed herein, the detailed description will be omitted.

Furthermore, the accompanying drawings are provided only for a better understanding of the embodiments disclosed herein and are not intended to limit technical concepts disclosed herein, and therefore, it should be understood that the accompanying drawings include all modifications, equivalents and substitutes within the concept and technical scope of the present disclosure. In addition, not only individual embodiments described below but also a combination of the embodiments may, of course, fall within the concept and technical scope of the present disclosure, as modifications, equivalents or substitutes included in the concept and technical scope of the present disclosure.

Hereinafter, the configuration and operation of the present disclosure will be described in more detail with reference to a number of drawings related to the present disclosure.

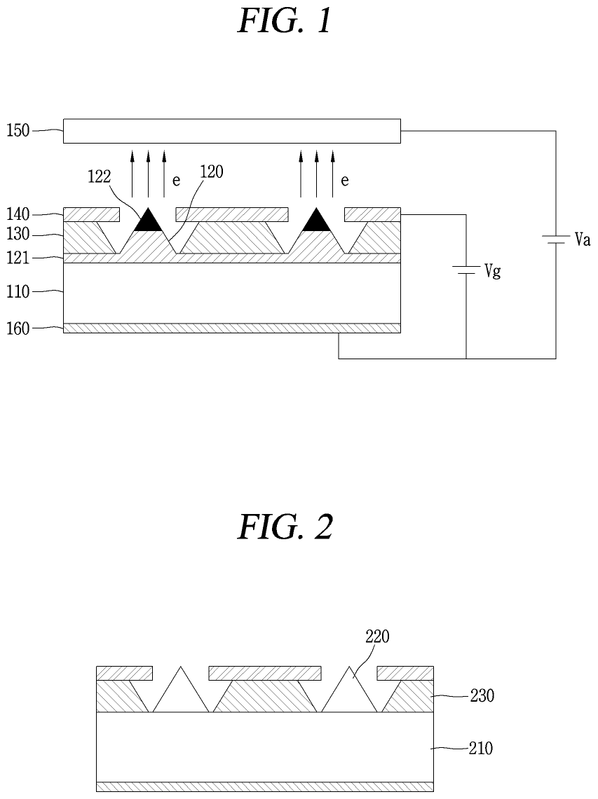

FIG. 1 is a conceptual diagram showing a probe-type field emission device integrated with a current limiting resistor.

Referring to FIG. 1, a field emission device provided with a current limiter (current limiting resistor) according to one embodiment of the present disclosure may include a silicon substrate 110, a plurality of probes 120 disposed on the silicon substrate, an insulating layer 130 disposed between the plurality of probes, a gate electrode 140 disposed on the insulating layer to emit electrons from the plurality of probes, an anode electrode 150 disposed to be spaced apart from the plurality of probes so as to allow electrons emitted from the plurality of probes to reach, and a cathode electrode 160 (or bottom electrode) disposed below the silicon substrate.

Here, the plurality of probes 120 in the field emission device of the present disclosure may be disposed with a highly resistive layer (or high doping layer) 120.

Specifically, the plurality of probes 120 may be disposed with a resistive layer 121 and a high doping layer 122, and may have a shape that becomes sharper toward the anode electrode 150 so as to facilitate electron emission.

The highly resistive layer may be formed of silicon grown as an epitaxial layer.

FIG. 2 is a conceptual diagram showing a conventional silicon probe-type field emission device.

In the related art, the structure of a conventional probe-type field emission device using a silicon wafer is as shown in FIG. 2.

Referring to FIG. 2, the probe-type field emission device has a structure in which a probe 220 is formed by etching a silicon wafer 210 and an insulating layer 230 and a gate electrode are disposed.

When a voltage is applied between the bottom electrode (or cathode) and the gate electrode in the probe-type field emission device, an electric field is concentrated on a sharp probe, and a tunnel barrier in vacuum becomes thinner.

This causes the electrons of the probe to be emitted into the vacuum through a tunneling phenomenon.

In this case, the tunneling current may be expressed by [Equation 1] and is very sensitive to a field enhancement factor (β).

$$J ( V , ϕ , β ) = 1.42 \times 1 {0}^{- 6} \times {β}^{- 2} \times exp ( \frac{10.4}{{Φ}^{1 / 2}} ) \times \frac{{V}^{2}}{Φ} exp ( - \frac{6.44 \times 1 {0}^{7} \times Φ}{V \times β} ) \qquad [ Equation 1 ]$$

The field enhancement factor is a value that represents an increase in the electric field on a probe surface depending on a shape of the probe, which is proportional to a height of the probe and inversely proportional to a radius of the probe.

Therefore, it is almost impossible to maintain the current density of all probes uniformly because the current density changes very sensitively to a shape of the tip of the probe, a degree of surface contamination, and the like.

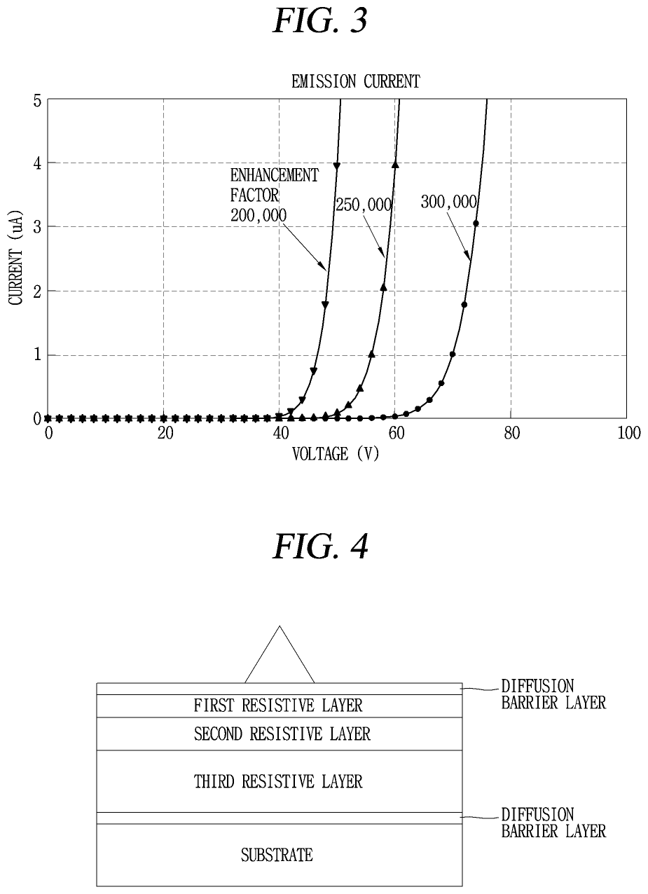

FIG. 3 is a graph showing the I-V characteristics of a probe-type field emission device.

Referring to FIG. 3, it is shown that the current density changes very sensitively depending on the field enhancement factor.

Therefore, when driven with the same voltage, some probes have a problem in that the current density is too high, which can cause the probe to be dull due to heat or cause an electrical short to the gate electrode, while other probes have a problem in that almost no tunneling current flows.

In order to solve this problem, referring to FIG. 4, a field emission device may consider a Mo probe using a Spindt process.

FIG. 4 is a conceptual diagram showing a current limiting structure of a Spindt probe-type field emission device.

In the case of the Mo probe using the Spindt process, it has a structure that limits the current by additionally allowing a resistive layer to be disposed under the probe.

However, it is difficult to develop an appropriate highly resistive material in this structure, and since the resistive layer is structured to be disposed in front under multiple probes, there is some interference between the probes.

Additionally, in the case of a silicon probe, the probe must be formed on a silicon wafer, so it is impossible to form a separate resistive layer under the silicon probe.

In the present disclosure, the structure and manufacturing method of a resistive layer that can be applied to the silicon probe are proposed.

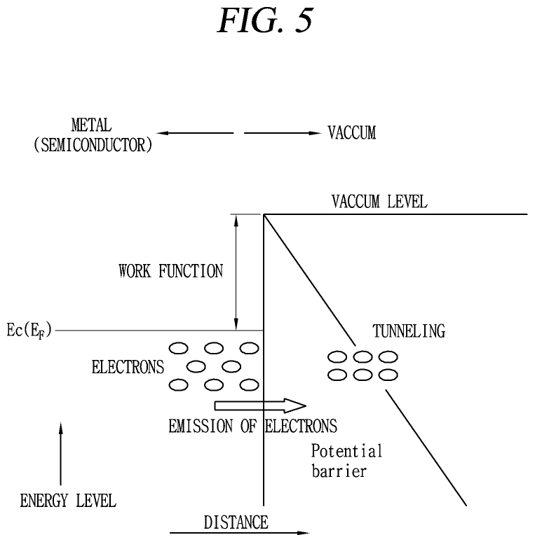

FIG. 5 is a conceptual diagram showing the principle of Fowler-Nordheim tunneling.

The driving principle of a field emission device refers, as shown in FIG. 3, to a phenomenon in which when a high electric field (e.g., 107 to 108 V/cm) is applied to a metal or semiconductor surface in a vacuum, a potential barrier on the semiconductor surface becomes thinner, and electrons are emitted into a vacuum state by a quantum mechanical tunneling effect in which electrons pass through the thinned potential barrier, which is called Fowler-Nordheim tunneling (F-N tunneling).

The most effective way to lower an electric field for F-N tunneling is to form a sharp probe on the order of several nanometers to tens of nanometers.

By forming the probe in this manner, an electric field may be concentrated at the tip of the probe in proportion to a height of a probe emitter as well as in inverse proportion to a radius of the tip of the probe, thereby reducing the drive voltage to several tens of V.

However, the tunneling current is very sensitive to the shape of the probe, making it very difficult to maintain a similar current density across the entire probe.

Referring to FIG. 3, even when the field enhancement factor due to a difference in shape of the probe increases by only 0.5 times, the tunneling current density increases by more than 10 times.

In the present disclosure, a negative feedback circuit using a resistor may be configured in each probe to maintain the current density of the probe uniformly.

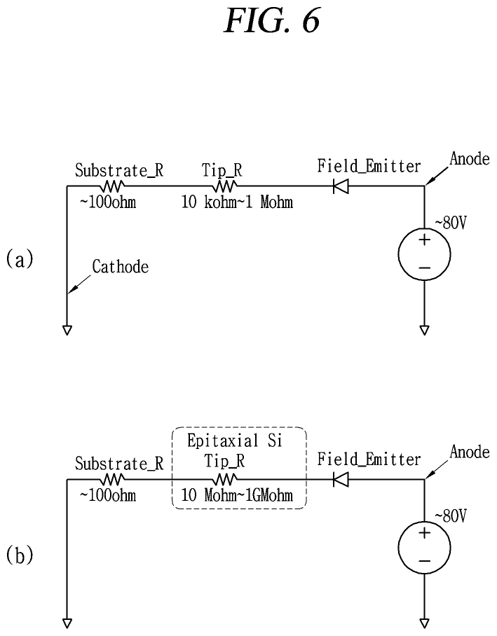

FIG. 6 is a drawing showing a silicon emitter circuit diagram of the present disclosure.

A conventional silicon emitter in (a) of FIG. 6 and a silicon emitter of the present disclosure in which epitaxial silicon is grown in (b) of FIG. 6 are compared with each other by using a simple circuit diagram.

The silicon emitter consists of a resistor of a substrate, a resistor of a probe, a probe that performs F-N tunneling, and an anode electrode. In this case, for the convenience of explanation, a two-pole electrode structure rather than a three-pole electrode structure as in FIG. 1 will be described.

A conventional silicon emitter is manufactured on a silicon substrate doped with phosphorus at a concentration of about 10\hat{ }14 to 10\hat{ }16 (atoms/cm\hat{ }3), and in this case, a resistance of each silicon tip is formed to be approximately 10 k (ohm) to 1M (ohm).

In contrast, the silicon emitter of the present disclosure has a highly resistive layer formed on the probe as shown in FIG. 1, and the highly resistive layer 121 may be formed of silicon (i.e., epitaxial silicon) grown as an epitaxial layer.

An impurity doping concentration of the epitaxial layer is manufactured to be approximately 10\hat{ }10 to 10\hat{ }13 (atoms/cm\hat{ }3), and a resistance of the probe may be formed to be approximately 10M (ohm) to 1G (ohm).

That is, a resistance of the probe due to the highly resistive layer may have a range of 10M to 1G (ohm).

The reason why epitaxial silicon is used to form the highly resistive layer is that the substrate and the probe are manufactured from the same substrate, so the highly resistive layer cannot be deposited separately as in the Spindt emitter.

Doping on a silicon substrate lowers the resistance, so a highly resistive layer cannot be formed on the substrate.

In order to solve this problem, the present disclosure epitaxially grows silicon with a low doping concentration on a silicon substrate so as to form a feedback resistor having a high resistance on each of a plurality of probes.

That is, in each of the plurality of probes 120 of the present disclosure, a feedback resistance is generated as the highly resistive layer is deposited.

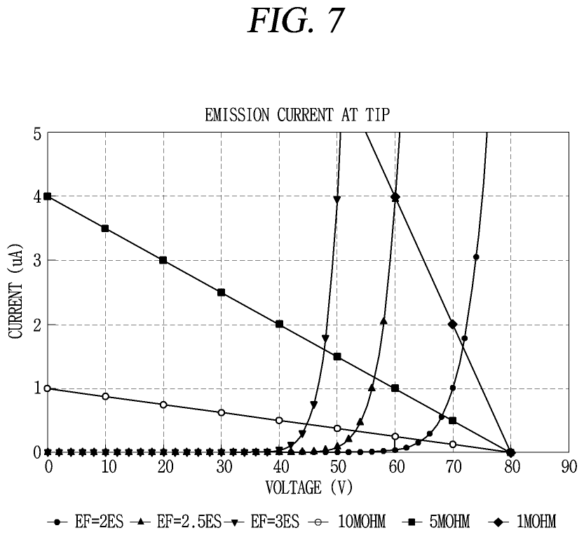

FIG. 7 is a graph showing a change in tunneling current due to resistance formation.

FIG. 7 shows a change in tunneling current due to a feedback resistor formed in each probe.

A curve shows a tunneling current in the case of no resistance at all.

In this case, the tunneling current differs significantly at the same voltage due to a difference in field enhancement factor (EF) caused by a difference in shape of the probe.

By forming a feedback resistor on the probe, a current is determined at a point where a curve and a straight line meet.

When a value of the feedback resistance is small, an absolute value of the tunneling current increases, but a current uniformity between individual probes deteriorates significantly.

In contrast, when a feedback resistance value increases, the current value decreases, but it becomes easier to maintain the current uniformly. That is, as the resistance value of the feedback resistor increases, the uniformity of the current increases.

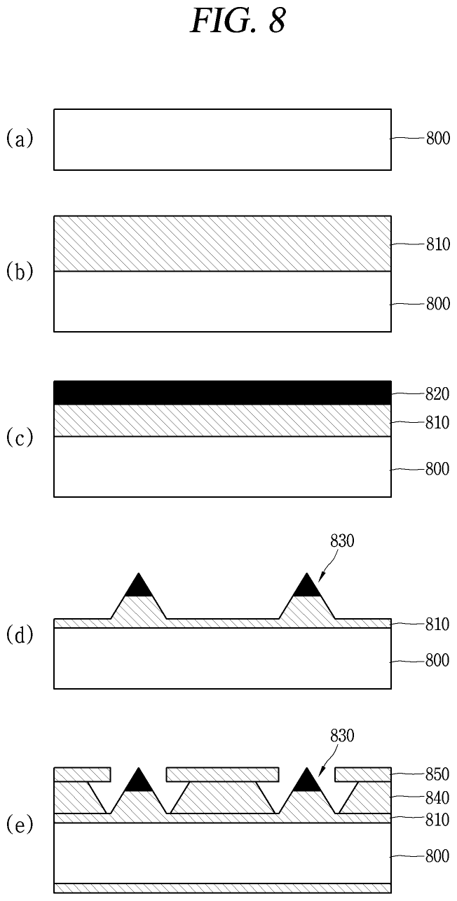

FIG. 8 is a process diagram for explaining a sequence of manufacturing a field emission device of the present disclosure.

Referring to (a) and (b) of FIG. 8, a method of manufacturing a field emission device according to the present disclosure may first grow an epitaxial silicon thin layer 810 on a silicon substrate 800.

The silicon substrate is mainly doped with phosphorus, and its resistivity has a range of about 1 to about 100 (ohm-cm).

Referring to (b) of FIG. 8, when depositing epitaxial silicon, a low concentration of phosphorus is deposited together to dope phosphorus in-situ or grow pure silicon without doping.

When doping with phosphorus, it is doped at a low concentration of about 10\hat{ }11 to 10\hat{ }13 (atoms/cm\hat{ }3) to form a high resistive layer, and has a resistivity of about 1 to about 100 k (ohm). Even when pure silicon is formed, it may be slightly doped due to diffusion of phosphorus by a subsequent heat treatment.

Referring to (c) of FIG. 8, in order to allow tunneling current to flow well on the probe surface, or in the case of undoped epitaxial silicon, phosphorus is implanted for doping.

In case of implantation, the dose concentration may be a concentration of about 10\hat{ }12 to about 10\hat{ }13.

That is, when the plurality of probes are silicon disposed with an undoped epitaxial layer, phosphorus 820 may be implanted.

That is, tips of the plurality of probes may be doped with phosphorus.

A subsequent process subsequent to implantation is similar to a manufacturing process of a general silicon emitter. The probes may be formed through silicon etching, and as shown in (d) of FIG. 8, a thermal oxide layer may be grown and then removed to form the probes 830 through tip sharpening.

Then, as shown in (e) of FIG. 8, an insulating thin layer 840 and a gate electrode 850 are formed to complete the device manufacturing.

There are several problems when electrons perform F-N tunneling through the silicon probes. First, a native oxide may be formed on the surface due to the oxidation of Si, which increases the driving voltage and causes a rapid increase in current during the breakdown of the oxide. Second, the silicon probe is very sharp at 5 nm due to oxidation sharpening, so the current is concentrated locally and the temperature easily rises, and the melting point of silicon is not high at 1410° C., so the tip of the probe easily melts.

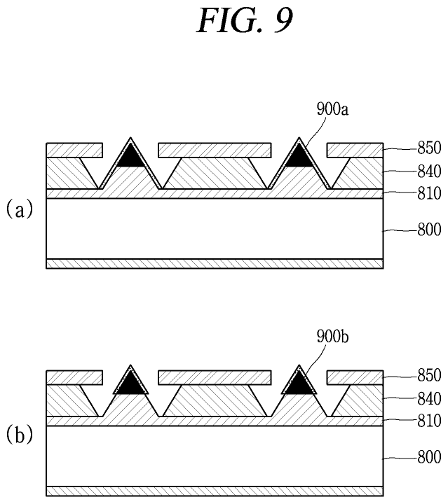

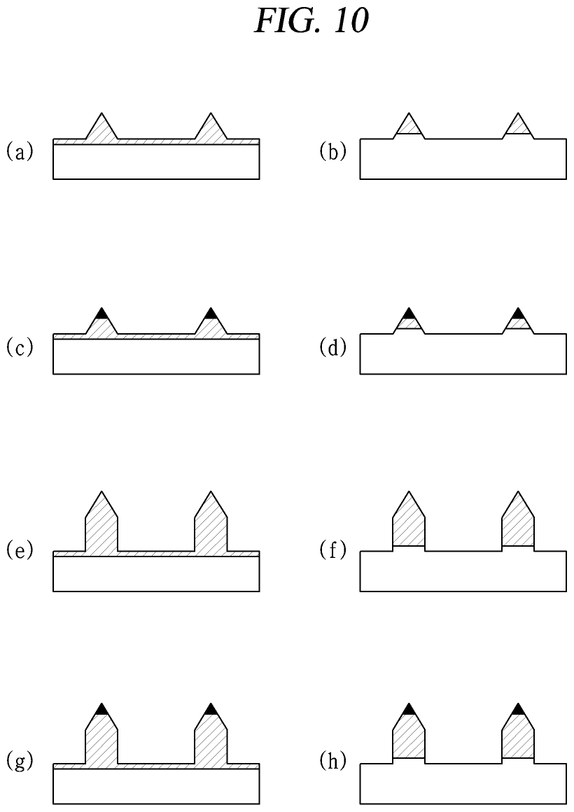

To this end, as shown in FIG. 9, a protective layer coating may be formed on the plurality of probes.

FIG. 9 is a conceptual view for explaining a protective layer coating according to one embodiment of the present disclosure.

Referring to FIG. 9, the present disclosure may coat the tip of the probe with a protective layer using various materials. FIG. 9 shows a protective layer coated on the probe.

Representative properties of a coating material require a high melting point, a resistance to oxidation, a low work function for good F-N tunneling, and excellent adhesion to a silicon probe.

Representative coating materials that can be used include a semiconductor such as diamond like carbon (DLC), diamond, a metal such as Pt, Mo, or the like, a silicide such as MoSi2, and a ceramic such as HfC.

As shown in (a) of FIG. 9, the present disclosure may form a protective layer coating over the entire probe, or as shown in (b) of FIG. 9, the protective layer coating may be formed only at the tip of the probe.

FIG. 10 is a conceptual diagram for explaining a probe structure according to various embodiments of the present disclosure.

FIG. 10 shows various probe structures of the present disclosure. The shape of the probe may be manufactured in various shapes by considering a concentration of epitaxial silicon, a driving voltage, and a thickness of an insulating layer. The formation of an insulating layer, a gate electrode, a protective layer, and the like subsequent to manufacturing the probe is similar to the method examined in FIG. 8.

A-types ((a), (c), (e), (g)) are configured such that the epitaxial layer extends to part of the silicon layer outside the probe, and B-types ((b), (d), (f), (h)) are configured such that the epitaxial layer exists only inside the probe.

In the case of the A-types, there is an advantage in that the resistance may be increased by extending the highly resistive epitaxial layer to the silicon substrate, but there is a problem in that mutual interference may occur between the probes because the resistance is not formed independently for each probe.

In contrast, the B-types have an advantage of forming the resistance independently for the probes and thus having no mutual interference, but have a problem of being difficult to increase the feedback resistance when the resistivity of the epitaxial layer is low.

(a) and (b) of FIG. 10 show probes formed using only an epitaxial layer. In this case, it is easy to increase the feedback resistance because the resistance increases as it goes towards the tip of the probe.

That is, as a height of the plurality of probes increases, a feedback resistance of the probes may increase.

However, there is a problem in that a temperature of the tip of the probe may increase because a resistance of the tip of the probe is high.

In order to solve this problem, (c) and (d) of FIG. 10 show a method of doping phosphorus into the tip of the probe using an implantation method to lower a resistance of the tip of the probe.

Due to this, there is a problem in that the overall feedback resistance is increased, but it may be possible to solve a problem in that the temperature of the tip of the probe is greatly increased locally.

The plurality of probes of the present disclosure may be formed through a dual etch such that a height of the plurality of probes is above a predetermined height.

(e), (f), (g), and (h) of FIG. 10 show a dual etch performed to increase the height of the probes. The reason for increasing the height of the probe is that, when the resistivity of the epitaxial layer is not sufficiently high, the feedback resistance value can be increased by increasing the height, and there is an advantage in that a thickness of the insulating layer for insulation from the gate electrode can be increased during device manufacturing (see FIG. 1).

The reason for increasing the thickness of the insulating layer is to prevent a phenomenon of insulation breakdown on a surface where the insulating layer and the vacuum meet.

Various methods may be used for the dual etch method, but etching is generally performed by the following method.

First, the etching process performs an isotropic etching that is etched vertically and horizontally to form a probe shape. The isotropic etching method performs dry etching using SF6/O2 gas or wet etching using an HF/HNO/CH3COOH solution.

Second, anisotropic etching is performed, which primarily etches in a vertical direction, to increase a height of the probe.

As an etching method, Cl2 gas, which is mainly used to etch poly-Si in a semiconductor process, or a deep RIE process, which is a Bosch process, may be used.

According to the present disclosure, a highly resistive epitaxial layer deposited on a silicon wafer is disposed with a highly resistive layer, thereby configuring a current limiting structure. Through this, a current uniformity between probes may be greatly enhanced, thereby greatly improving reliability.

Therefore, the detailed description should not be limitedly construed in all of the aspects, and should be understood to be illustrative. The scope of the present disclosure should be determined by reasonable interpretation of the appended claims and all changes that come within the equivalent scope of the present disclosure are included in the scope of the present disclosure.

1. A field emission device having an automatic current limiter, the field emission device comprising:
a silicon substrate;
a plurality of probes disposed on the silicon substrate;
an insulating layer disposed between the plurality of probes;
a gate electrode disposed on the insulating layer to emit electrons from the plurality of probes;
an anode electrode disposed to be spaced apart from the plurality of probes so as to allow electrons emitted from the plurality of probes to reach; and
a cathode electrode disposed below the silicon substrate,
wherein the plurality of probes are disposed with a highly resistive layer.

2. The field emission device of claim 1, wherein the highly resistive layer is formed of silicon grown as an epitaxial layer.

3. The field emission device of claim 1, wherein a resistance of the probe due to the highly resistive layer has a range of 10M to 1G (ohm).

4. The field emission device of claim 1, wherein a feedback resistance is generated on each of the plurality of probes as the highly resistive layer is deposited.

5. The field emission device of claim 4, wherein a uniformity of a current increases as a resistance value of the feedback resistor increases.

6. The field emission device of claim 1, wherein tips of the plurality of probes are doped with phosphorus.

7. The field emission device of claim 1, wherein phosphorus is implanted when the plurality of probes are silicon disposed with an undoped epitaxial layer.

8. The field emission device of claim 1, wherein a protective layer coating is disposed on the plurality of probes.

9. The field emission device of claim 1, wherein the feedback resistance of the probe increases as a height of the plurality of probes increases.

10. The field emission device of claim 9, wherein the plurality of probes are formed through a dual etch so as to allow the height of the plurality of probes to be above a predetermined height.
